(19) United States
(12) Patent Application Publication
(10) Pub. No.: US 2002/0009278 A1
(43) Pub. Date: Jan. 24, 2002

(54) Optic fiber management module and furniture incorporating same

(76) Inventors: Laurence H. Fingler, King Township (CA); L. Scott Fingler, Summerside (CA); Geoffrey P. Laycock, Schomberg (CA)

Correspondence Address: Patricia Smink Rogowski, Connolly Bove Lodge & Hutz LLP, P.O. Box 2207, Wilmington, DE, 19899, US

(21) Appl. No.: 09/798,126

(22) Filed: Mar. 2, 2001

Related U.S. Application Data
(60) Provisional application No. 60/186,903, filed on Mar. 3, 2000.

(51) Int. Cl. G02B 6/00

(52) U.S. Cl. 385/135

(57) ABSTRACT

An optic fiber management module includes an optic fiber distributor to receive a multi-fiber optic cable and to fan out individual optic fibers of the cable to individual first connectors. A plurality of optic fiber sources each of which includes an optic fiber is also provided. Each optic fiber has one end coupled to a respective one of the first connectors and an opposite end having a second connector thereon. Each optic fiber is extendible from the respective first connector to an end use thereby to bring the second connector to the end use. A furniture system incorporating the optic fiber management module is also provided.

### FIELD OF THE INVENTION

The present invention relates to fiber optics and in particular to an optic fiber management module to be installed within a furniture system to distribute optical fiber to individual workstations. The present invention also relates to a furniture system incorporating an optic fiber management module.

### BACKGROUND OF THE INVENTION

In today's office environment, portable workstations are replacing permanent walled offices. Workstations of this nature allow offices to be reconfigured quickly to meet changing needs. In order to be effective, these portable workstations need to provide suitable connections for workstation equipment such as computers, telephones etc. to communication networks. Unfortunately, current furniture system designs have failed to keep pace with office environment needs.

It is therefore an object of the present invention to provide a novel optic fiber management module and a furniture system incorporating the same.

### SUMMARY OF THE INVENTION

According to one aspect of the present invention there is provided an optic fiber management module comprising:

an optic fiber distributor to receive a multi-fiber optic cable and to fan out individual optic fibers of said cable to individual first connectors; and

a plurality of optic fiber sources each of which includes an optic fiber, each optic fiber having one end coupled to a respective one of said first connectors and an opposite end having a second connector thereon, each said optic fiber being extendible from said respective first connector to an end use thereby to bring the second connector to said end use.

Preferably, the one end of each optic fiber has a connector thereon to mate releasably with the respective one of the first connectors. It is also preferred that each of the optic fiber sources includes a spool loaded with a length of optic fiber. In one embodiment, the optic fiber management module further includes a bracket on which the optic fiber distributor and optic fiber sources are mounted. A plurality of posts extends from the bracket, with each post removably supporting a plurality of spools.

Preferably, the fiber optic distributor includes a third connector to receive releasably the multi-fiber optic cable and a plurality of optic fibers interconnecting the third connector and the first connectors. It is also preferred that the first and second connectors are MTJR connectors and the third connector is an MTP connector.

According to another aspect of the present invention there is provided a furniture system comprising:

a plurality of workstations; and

an optic fiber management module mounted on one of said workstations, said optic fiber management module including:

a mounting bracket;

an optic fiber distributor on said mounting bracket to receive a multi-fiber optic cable and to fan out individual optic fibers of said cable to individual first connectors; and

a plurality of optic fiber sources on said mounting bracket each of which includes an optic fiber, each optic fiber having one end coupled to a respective one of said first connectors and an opposite end having a second connector thereon, each said optic fiber extending from said respective first connector to a respective one of said workstations thereby to bring the second connector to said respective one of said workstations.

The present invention provides advantages in that the optic fiber management module allows furniture systems to be wired easily and effectively with optic fiber thereby to facilitate the connection of workstation equipment to communication networks.

### BRIEF DESCRIPTION OF THE DRAWINGS

An embodiment of the present invention will now be described more fully with reference to the accompanying drawings in which:

FIG. 1 is a perspective view of an optic fiber management module in accordance with the present invention;

FIG. 2 is a perspective view of a mounting bracket forming part of the optic fiber management module of FIG. 1;

FIG. 3 is a perspective view of an optic fiber distributor forming part of the optic fiber management module of FIG. 1;

FIG. 4 is a side elevational view of a furniture system incorporating the optic fiber management module of FIG. 1; and

FIG. 5 is a side elevational view of another furniture system incorporating the optic fiber management module of FIG. 1.

### DETAILED DESCRIPTION OF THE PREFERRED EMBODIMENT

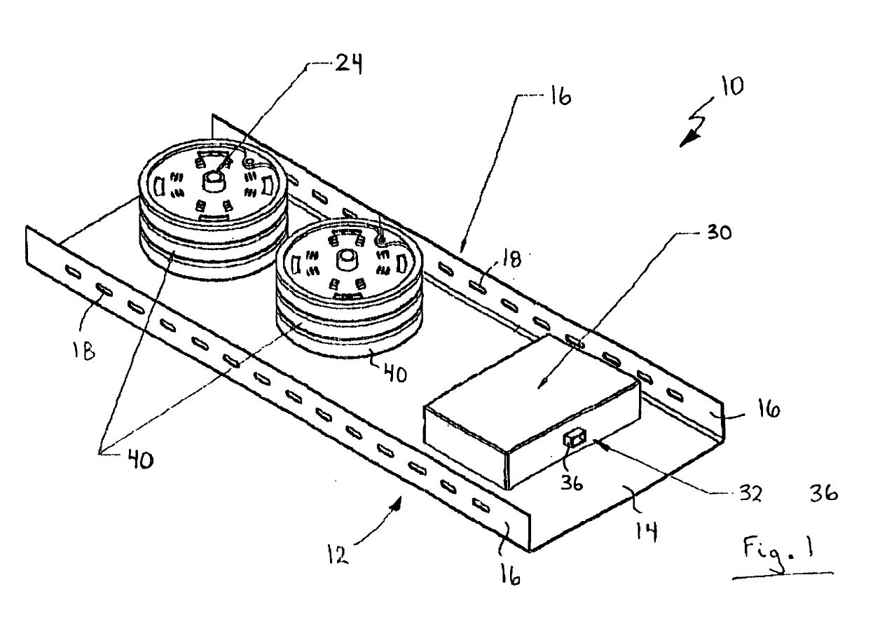

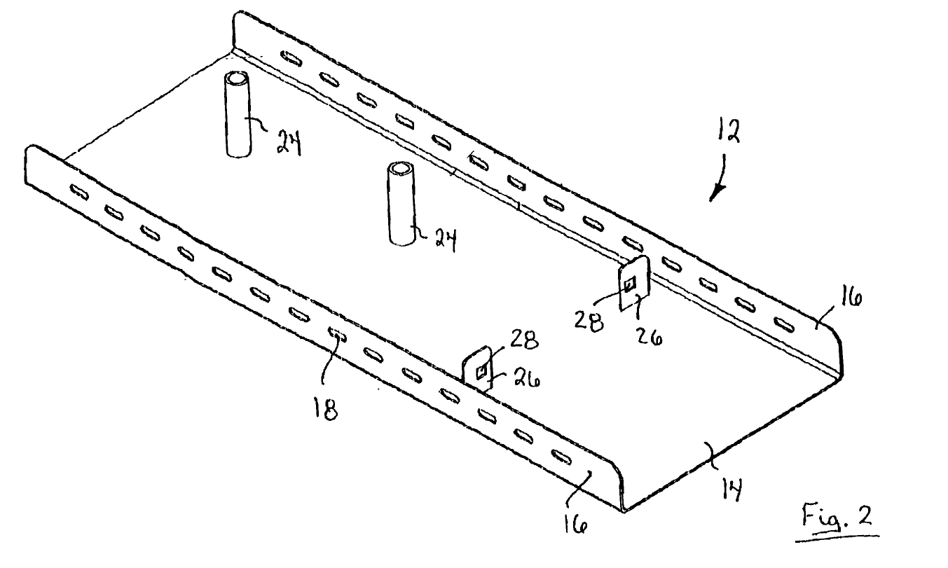

Turning now to FIGS. 1 to 3, an optic fiber management module in accordance with the present invention is shown and is generally identified by reference numeral 10. As can be seen, optic fiber management module 10 includes a steel mounting bracket 12 having a rectangular base 14 with flanges 16 running along its opposite major side edges. Spaced, elongate mounting holes 18 are provided in the flanges 16 to enable the bracket 12 to be secured to a workstation.

A pair of upright spaced, hollow spool posts 24 is welded to the base 14 nearer one of its ends. A pair of upstanding tabs 26 also extends from the base 14 nearer the other of its ends. Each tab 26 has a hole 28 provided therethrough. Secured to the tabs 26 by way of fasteners (not shown) is an optic fiber distribution module 30 designed to “fan out” optic fiber from a multi-fiber optic cable.

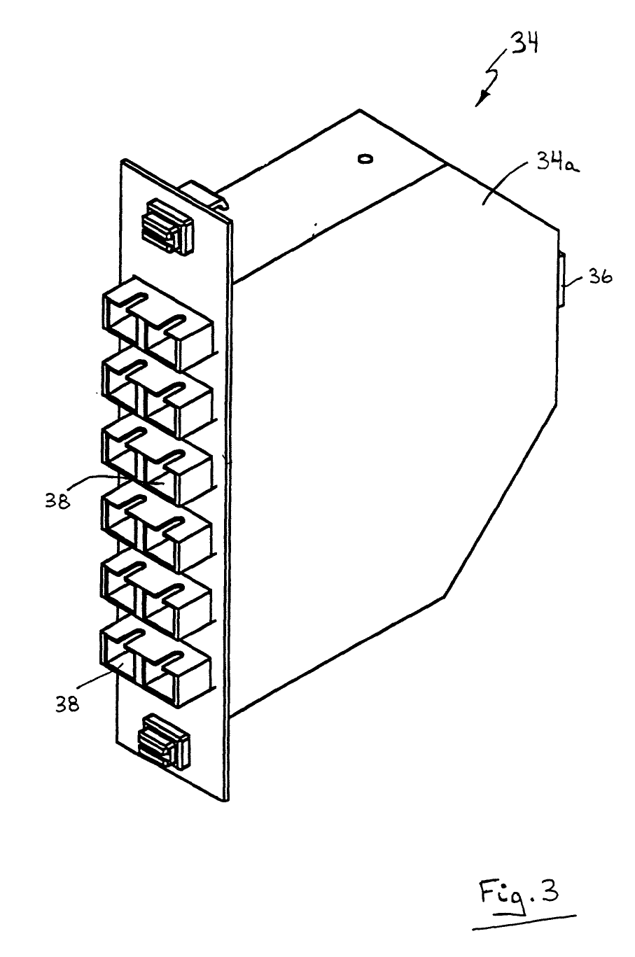

The optic fiber distribution module 30 includes an optic fiber distributor 34 as best illustrated in FIG. 3. Optic fiber distributor 34 includes a body 34a having an MTP connector 36 one on side of the body 34a. A plurality, (in this example twelve), of MTRJ connectors 38 is provided on an opposite side of the body 34a. Optic fibers (not shown) within the body 34a connect the MTP connector 36 to the individual MTRJ connectors 38. In this manner, the individual fibers of a multi-fiber optic cable coupled to the MTP connector 36 can be fanned out to the individual MTRJ connectors 38. A shallow U-shaped cover 32 overlies the optic fiber distributor 34 in a manner so that the MTP connector 36 and the MTRJ connectors 38 remain exposed.

A plurality of optic fiber spools 40 are removably loaded onto each of the spool posts 24. In this particular example, three optic fiber spools 40 are shown loaded onto each spool post 24 for illustrative purposes. Each optic fiber spool 40 is preloaded with an appropriate length of optic fiber 42. The ends of each optic fiber 42 have MTRJ connectors fitted thereon. In this way, one end of each optic fiber 42 can be releasably coupled to an MTRJ connector 38. Each optic fiber 42 can be unwound from the spool 40 so that its other end terminates at a desired location.

In the present embodiment, the optic fiber management module 30 is designed to be used with a furniture system to allow the individual fibers in a multi-fiber optic cable to be fanned out to individual workstations of the furniture system.

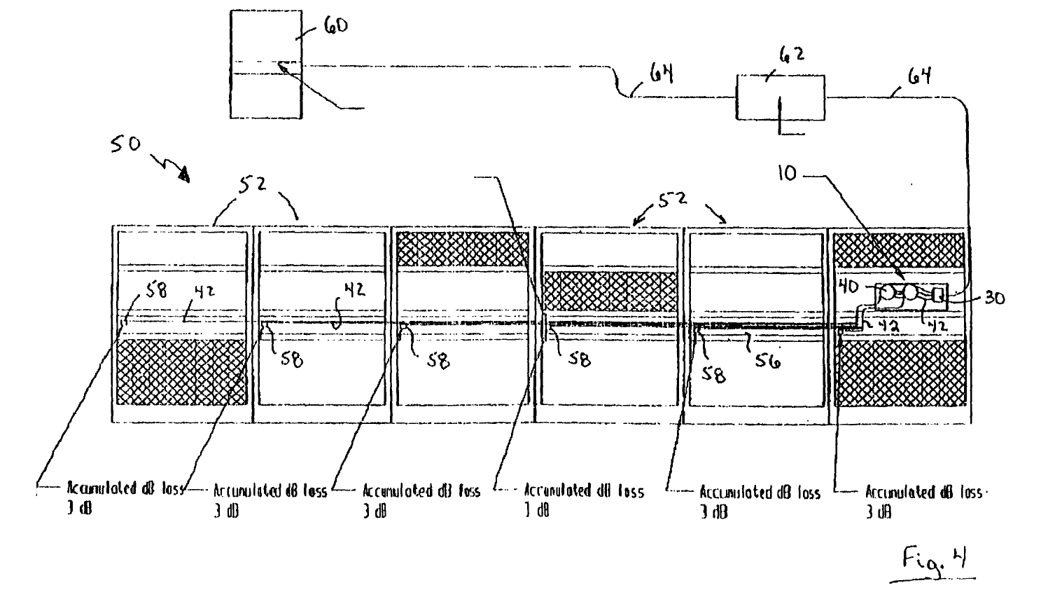

Turning now to FIG. 4, a furniture system 50 including a plurality of workstations 52 is shown. The optic fiber management module 10 is secured to the back of one of the workstations 52 via fasteners (not shown) passing through the mounting holes 18 in the flanges 16 of bracket 12.

Spools 40 with the appropriate lengths of optic fiber 42 necessary to wire the workstations 52 are loaded onto the spool posts 24. Each spool 40 is associated with one of the workstations 52 and includes an appropriate length of optic fiber sufficient to extend between its associated workstation 52 and one of the MTRJ connectors 38. The optic fiber 42 loaded on each spool 40 is unreeled from the spool 40 so that one of its ends is positioned at its associated workstation 52. As the optic fiber 42 is unreeled from the spool 40, it is laid in wiring channels 56 provided by the workstations. The end of the optic fiber 42 is then terminated either at an MTRJ connector 58 provided on the workstation 52 or at an MTRJ connector on workstation equipment (not shown). Although not shown, a grommet accommodated by the workstation 52 is used to secure the optic fiber 42 to the workstation 52. The other end of the optic fiber 42 is unhooked from the spool 40 and its MTRJ connector is coupled to one of the MTRJ connectors 38 of the optic fiber distributor 34. With the furniture system 50 wired in this manner, the optic fiber distribution module 30 can be coupled to a computer server 60 via multi-fiber optic cable 64 extending between a zone box 62 and the MTP connector 36 and between the zone box 62 and the computer server 60.

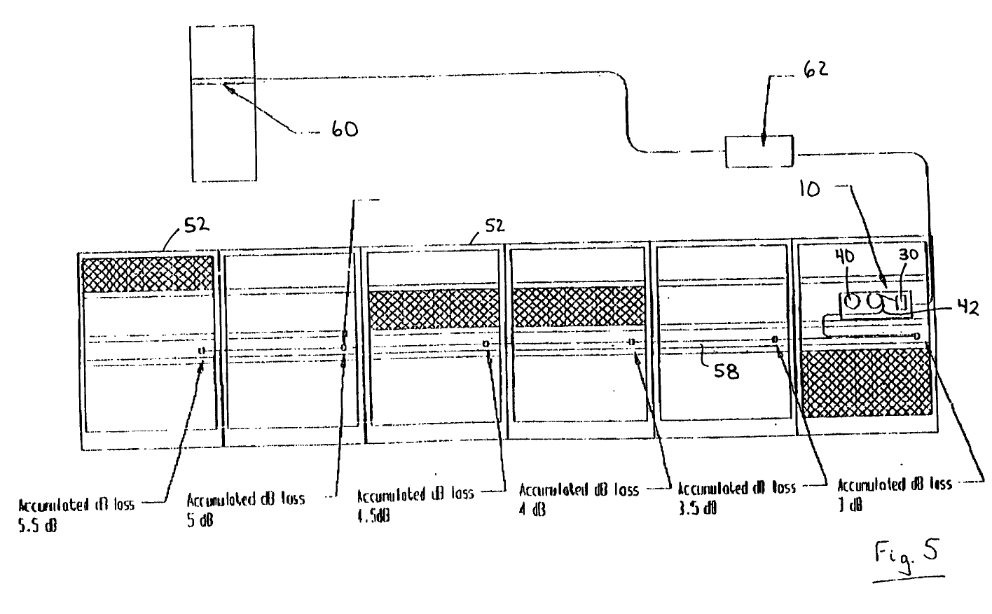

In an alternative embodiment as shown in FIG. 5, each spool 40 is loaded with the same length of optic fiber 42. A bracket (not shown) having a plurality of MTRJ connectors thereon is secured to the first workstation 52. The optic fiber 42 of each spool 40 is coupled to one of the MTRJ connectors on the bracket and to one of the MTRJ connectors 38 of the optic fiber distributor 34. Standard patch cords are then laid in the wiring channels 56 and run from the MTRJ connectors on the bracket to the individual workstations 52.

As will be appreciated, the optic fiber management module 10 allows furniture systems to be wired with optic fiber in an easy and efficient manner. Although a preferred embodiment of the present invention has been described, those of skill in the art will appreciate that variations and modifications may be made without departing from the spirit and scope thereof as defined by the appended claims.

We claim:

1. An optic fiber management module comprising:
an optic fiber distributor to receive a multi-fiber optic cable and to fan out individual optic fibers of said cable to individual first connectors; and
a plurality of optic fiber sources each of which includes an optic fiber, each optic fiber having one end coupled to a respective one of said first connectors and an opposite end having a second connector thereon, each said optic fiber being extendible from said respective first connector to an end use thereby to bring the second connector to said end use.

2. An optic fiber management module as defined in claim 1 wherein the one end of each optic fiber has a connector thereon to mate releasably with said respective one of said first connectors.

3. An optic fiber management module as defined in claim 2 wherein each of said optic fiber sources includes a spool loaded with a length of optic fiber.

4. An optic fiber management module as defined in claim 3 further including a bracket on which said optic fiber distributor and optic fiber sources are mounted.

5. An optic fiber management module as defined in claim 4 further including a plurality of posts extending from said bracket, each of said posts removably supporting at least one spool.

6. An optic fiber management module as defined in claim 5 wherein each post supports a plurality of spools.

7. An optic fiber management module as defined in claim 3 wherein each spool is loaded with a different length of optic fiber.

8. An optic fiber management module as defined in claim 4 wherein said fiber optic distributor includes a third connector to receive releasably said multi-fiber optic cable and a plurality of optic fibers interconnecting said third connector and said first connectors.

9. An optic fiber management module as defined in claim 8 wherein said first and second connectors are MTRJ connectors and wherein said third connector is an MTP connector.

10. A furniture system comprising:
a plurality of workstations; and
an optic fiber management module mounted on one of said workstations, said optic fiber management module including:
a mounting bracket;
an optic fiber distributor on said mounting bracket to receive a multi-fiber optic cable and to fan out individual optic fibers of said cable to individual first connectors; and
a plurality of optic fiber sources on said mounting bracket each of which includes an optic fiber, each optic fiber having one end coupled to a respective one of said first connectors and an opposite end having a second connector thereon, each said optic fiber extending from said respective first connector to a respective one of said workstations thereby to bring the second connector to said respective one of said workstations.

11. A furniture system as defined in claim 10 wherein said workstations include wiring channels to accommodate said optic fibers.

12. A furniture system as defined in claim 11 wherein the one end of each optic fiber has a connector thereon to mate releasably with said respective one of said first connectors.

13. A furniture system as defined in claim 12 wherein each of said optic fiber sources includes a spool loaded with a length of optic fiber.

14. A furniture system as defined in claim 13 further including a plurality of posts extending from said bracket, each of said posts removably supporting at least one spool.

15. A furniture system as defined in claim 14 wherein each post supports a plurality of spools.

16. A furniture system as defined in claim 13 wherein said fiber optic distributor includes a third connector to receive releasably said multi-fiber optic cable and a plurality of optic fibers interconnecting said third connector and said first connectors.

17. A furniture system as defined in claim 17 wherein said first and second connectors are MTRJ connectors and wherein said third connector is a MTP connector.
